(19) United States
(12) Patent Application Publication
(10) Pub. No.: US 2007/0001826 A1
(43) Pub. Date: Jan. 4, 2007

(54) Electronic key system for vehicles

(75) Inventors: Donna Lanier, Ocala, FL (US); Rande Newberry, Crystal River, FL (US); Tony Lebron, Brooksville, FL (US)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: KEY CONTROL TECHNOLOGIES, INC., OCALA, FL (US)

(21) Appl. No.: 11/264,499

(22) Filed: Oct. 31, 2005

Related U.S. Application Data
(63) Continuation-in-part of application No. 11/170,885, filed on Jun. 30, 2005.

(51) Int. Cl. B60Q 1/00; G08B 13/00

(52) U.S. Cl. 340/425.5; 340/5.54; 307/10.4

(57) ABSTRACT

A keypad-based security system limits access to the ignition of a gas powered vehicle such as a golf or utility cart, to authorized operators having authorized ID codes. The security system, which is easily retrofit to existing vehicles, is interposed between the vehicle's ignition switch and the switch circuit of the vehicle. ID codes input by the operator using an on-board keypad are compared with a set of authorized ID codes stored in a memory, and a relay is energized to connect the ignition switch to the switch circuit with the energy source when the input ID code is verified as matching one of the authorized ID codes stored in the memory. The keypad uses only five keys to input a four digit ID code comprising any of the digits from 0 to 9.

### CROSS-REFERENCE TO RELATED APPLICATION

This is a continuation in part of U.S. patent application Ser. No. 11/170,885 entitled Electric Key System for Golf Carts filed Jun. 30, 2005.

### TECHNICAL FIELD

The present invention generally relates to anti-theft and security devices for vehicles, deals more particularly with an electronic key system for controlling the use of gas powered vehicles.

### BACKGROUND OF THE INVENTION

Numerous electronic anti-theft systems and keyless ignition devices have been developed for conventional, full size passenger vehicles, but little progress has been made in devising similar systems for small, off road vehicles, particularly those that are gas powered, such as golf carts. Theft and unauthorized use of golf carts resulting in abuse and vandalism are a significant problem, particularly for businesses controlling fleets of such vehicles, such as golf courses. Golf carts are often left unguarded in open, relatively isolated areas, making them easy prey for thieves and vandals using an industry standard key system. Moreover, the ignition control systems in these vehicles are relatively simplistic and readily accessed by unauthorized vehicle operators or thieves. In many cases, the only access control consists of a key used by driver to turn the ignition on/off, thereby connecting the vehicle's battery to the vehicle's gas drive motor.

Prior attempts at providing anti-theft controls for gas powered carts have been essentially limited to mechanical solutions. For an example, it has been proposed to provide mechanical locks on a wheel or the steering column of the vehicle to discourage theft or unauthorized vehicle use. Mechanical solutions to the problem have not been completely effective, and suffer from disadvantage that structural modifications of the vehicle are often necessary to install the mechanical anti-theft device. Furthermore, these mechanical anti-theft devices can be difficult to operate, particularly for users who are unfamiliar with their construction or operation.

Accordingly, there is a clear need for a fully electronic security system for controlling access to the ignition of a gas powered golf cart or similar as powered vehicle, which is simple in construction, easy to use and can be installed with minimum effort. The present invention is directed toward satisfying this need in the art.

### SUMMARY OF THE INVENTION

According to one aspect of the invention, an electronic security system for controlling the use of a gas powered vehicle such as a golf cart is provided with a keypad for allowing an authorized operator of the vehicle to input an identification code (ID) code that uniquely identifies the operator. An electrically controllable switch selectively enables operation of the ignition. A controller is responsive to the ID code input by the keypad for controlling the switch to enable operation of the ignition.

According to another aspect of the invention, a security system is provided for restricting access to the ignition of a gas powered vehicle, such as a golf cart, to authorized operators. The system includes a keypad for allowing an authorized operator of the vehicle to input an identification code (ID) code uniquely identifying the operator, and a control circuit coupled between an ignition switch on the vehicle and an on-board source of electrical energy used to power the vehicle. The control circuit includes (a) a memory for storing a plurality of ID codes respectively associated with authorized operators of the vehicle, (b) an electrically controllable switch for selectively coupling the ignition switch in a circuit with the electrical energy source, and (c) a controller for comparing the input ID code with each of the plurality of ID codes stored in the memory and for actuating the controllable switch to couple the ignition switch in circuit with the electrical storage source when the input ID code matches one of the ID codes stored in the memory.

According to still another aspect of the invention, a method is provided for restricting access to the ignition of a gas powered vehicle, such as a golf cart, to authorized operators, which comprises the steps of: assigning an ID code to each of a plurality of authorized vehicle operators; storing the assigned ID codes in a memory; receiving an ID code input by an operator seeking access to the ignition; comparing the input ID code with the stored plurality of ID codes; and, enabling the ignition when the compared ID code matches one of the stored ID codes.

Accordingly, is a primary object of the present invention to provide a fully electronic security system to prevent unauthorized use of gas powered vehicles, such as gas powered golf or utility carts.

A further object of the invention is to provide an electronic key system as described above which is easily retrofitted on existing golf carts, without major modifications to vehicle.

Another object of the invention is to provide a system of the type mentioned above which is sealed from the environment and is thus suitable for use with open vehicles where the system is subjected to environment elements.

Another object of the invention is to provide an illuminated keypad to help an operator access the gas powered cart in a low or no light environment.

A still further object of the invention is to provide a system as described above which allows a system administrator or maintenance person to troubleshoot or reprogram the system using fully electronic techniques.

Another object of the invention is to provide a system of the type referred to above, which does not rely on mechanical locks or keys, and is not easily circumvented by unauthorized user.

These, and further objects and advantages of the invention will be made clear or will become apparent during the course of the following description of a preferred embodiment of the invention.

### BRIEF DESCRIPTION OF THE DRAWINGS

In the drawings, which form an integral part of the specification and are to be read in conjunction therewith, and in which like reference numerals are employed to designate identical components in the various views:

FIG. 1 is a perspective view of the electronic key system forming the preferred embodiment of the invention:

FIGS. 2A-2B are simplified, block diagrams of circuits showing the electronic key system installed in the ignition circuit of a gas powered vehicle;

FIG. 3 is a plan view of the system shown in FIG. 1;

FIG. 4 is an exploded, sectional view of the device shown in FIG. 1, taken along the line 4-4 in FIG. 3;

FIG. 5 is a simplified, block diagram of the electronic key system;

FIG. 6 is a detailed schematic diagram of a circuit forming part of the electronic key system; and,

FIG. 7 is a flow chart showing the steps performed in using the electronic key system.

### DETAILED DESCRIPTION OF A PREFERRED EMBODIMENT OF THE INVENTION

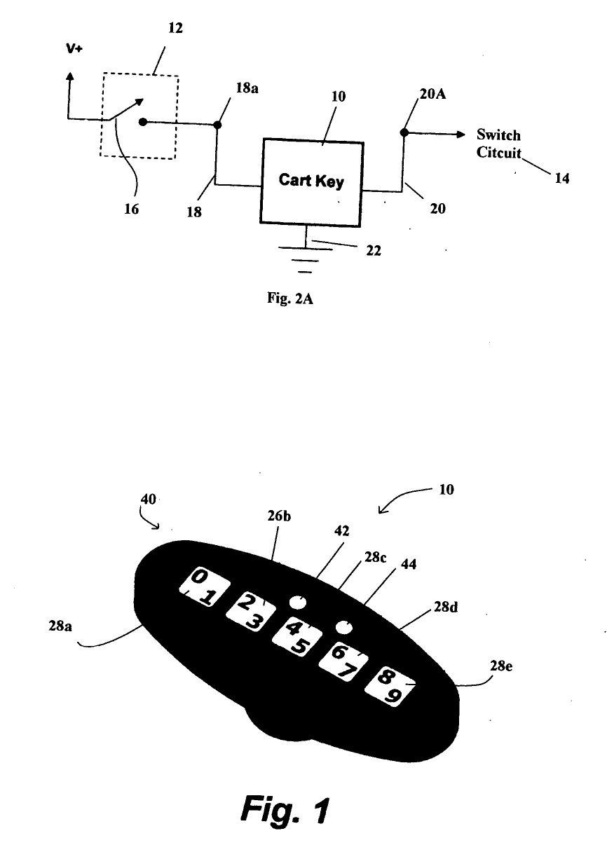

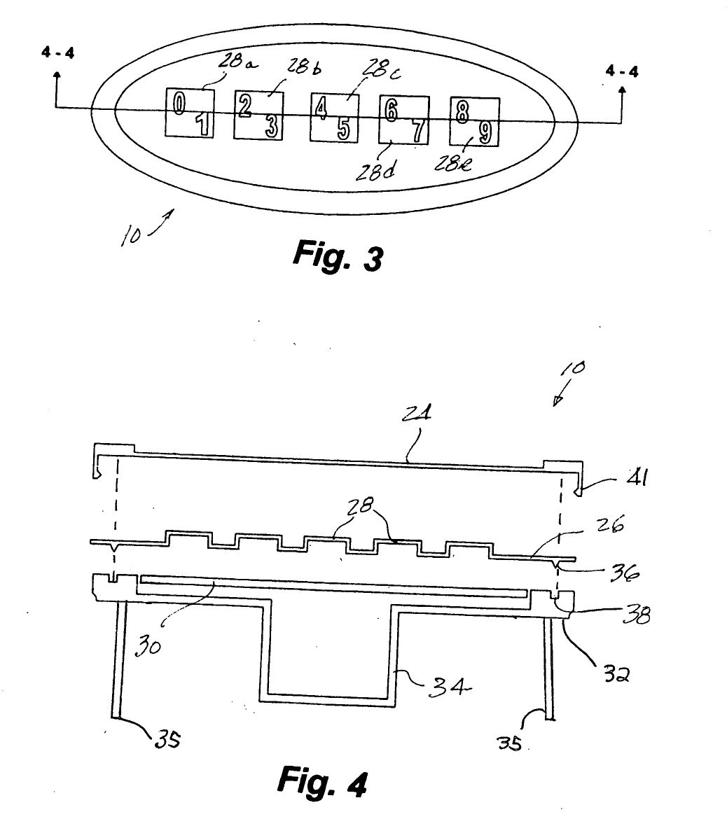

Referring first to FIGS. 1-4, the present invention involves a gas powered vehicle security system in the form of an electronic key system 10, sometimes referred to herein as a “security system.” The security system 10 functions as an anti-theft device to prevent unauthorized users from using a gas powered vehicle, such as a golf cart or other gas powered vehicles in which the security system 10 has been installed. While the electronic key system 10 will be described herein in connection with a golf cart for illustrative purposes, it is to be understood that the security system 10 maybe advantageously employed in virtually any gas powered vehicle driven by a gas motor powered by an onboard power supply, such as a battery, energy cell, or other like devices.

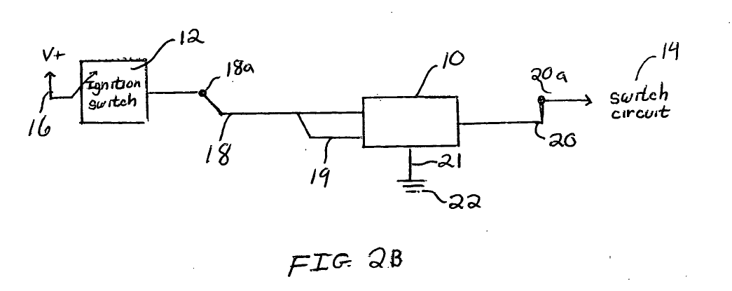

The security system 10 comprises an environmentally sealed housing assembly 40 containing later described electronic circuitry. Referring to FIG. 2A, the security system 10 is installed in an ignition circuit of the vehicle between an ignition switch 12 and the switch circuit 14. The ignition switch 12 includes a single pole, double throw electrical switch 16, normally directly connects a power supply (V+) directly to the switch circuit 14, and more particularly to enable an electric drive motor (not shown) to supply the motor with electrical power. The security system 10 is installed in the ignition circuit by connecting a pair of leads 18, 20 to the ignition switch 12 using a pair corresponding terminal connections 18a, 20a. It may thus be appreciated that even though the ignition switch 12 is closed, actual connection of the power supply (V+) to the switch circuit 14 is dependent upon the operational state of the security system 10.

Referring to FIG. 2B, a wire harness can include four electrical wires connected to the printed circuit board 30 with the electrical system of the vehicle. A first wire 18 of the wire harness is connected to the security system 10 in series with the ignition switch 12 using a terminal connection 18a. A second wire 20 is connected to the switch circuit 14 using a terminal connection 20a. For a positive switched ignition system a third wire 21 is connected to a ground 22, such as a battery ground, and the final wire 19 is connected to the primary (first) wire 19 of the security system 10.

As shown in FIG. 4, the structural components of the housing assembly 40 includes a hollow, oval shaped case 32 within which there is rigidly held a printed circuit board 30. A keypad 26 includes a flexible membrane provided with a plurality of raised areas 28 defining the keys 28a-28e. The individual keys 28a-28e are arranged along a common axis, and each of the key has two numbers designated thereon (0-9) so that these five keys 28a-28e can be used to input any combination of the numbers 0-9.

The keypad 26 is provided with an alignment tab 36 along the outer edge thereof which is received in a corresponding groove 38 in the upper face of the case 32 to hold the raised key areas 28 in registration above printed circuit elements (not shown) defining key switches. The housing assembly 40 further includes a bezel cover 24 having a peripheral clip 41 that is received in snap-fit relationship on a sidewall of the case 34. The bezel cover 24 provides a decorative edge cover and helps seal the assembly against environmental elements entering the housing assembly 40 between the case 32 and the membrane defining the keypad 26. The bottom of the case 30 includes a cylindrically shaped mounting projection 34 and also cylindrically shaped mounting posts 35 which facilitates alignment and installation of the keypad 26 on a dashboard or other flat surface of the golf cart.

Alternatively, the bottom face of the case 32 may be provided with an adhesive backing having a protective, peel-off layer that can be removed to allow the adhesive layer to be pressed into face to face contact with a mounting surface on the vehicle, thereby holding the security system 10 in place.

During installation, a central circular openings and a pair of peripheral openings are cut in the dashboard of the vehicle, with the central opening configured and dimensioned to receive the mounting projection 34 and the peripheral openings are configured and dimensioned to receive the mounting posts 35. The mounting projection 34 and the mounting posts 35 are inserted into the openings so that the bottom face of the case 32 fits flush against vehicle mounting surface. The case 32 and bezel 24 may be made of any suitable material however it has been found that a UV resistant ABS is particularly desirable.

The keypad 26 may be provided with adhesive on one face thereof to secure it to the upper face of case 32, and aid in forming an environmentally tight seal to protect against weather elements. The raised key areas 28 are preferably translucent so that the keys 28a-28e can be back lighted, as with LEDs. The security system 10 can further include red and green LEDs 42, 44 respectively, in the upper face of housing assembly 40, to indicate system status.

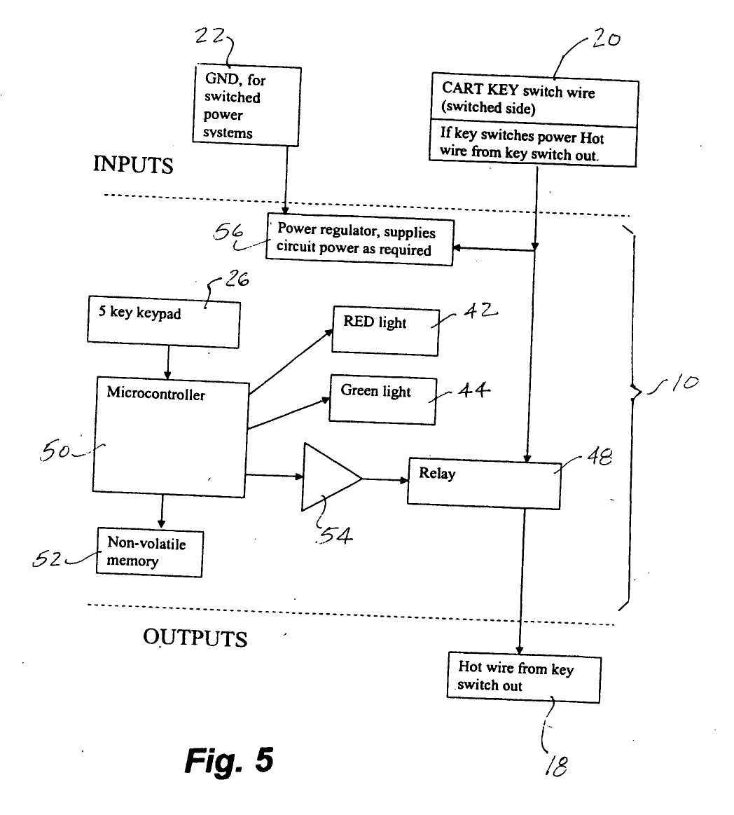

The primary components of the security system 10 and their connections to the vehicle, are depicted in FIG. 5. The security system 10 is connected to ground 22 for a positive switched ignition system. The ground 22 is connected to a suitable power regulator which supplies power to the electronic circuits of the security system 10. Similarly, the hot wire 18 from the ignition switch 12 is connected to the relay 48. The relay 48 functions to selectively couple the hot wire from the ignition switch 12 to switch (second) wire 20, thereby enabling the ignition system. The security system 10 includes a microcontroller 50 provided with non-volatile memory 52 for storing programs and user (operator) ID codes therein. The ID codes and information are input to the microcontroller 50 using the keypad 26. The microcontroller 50 compares the code information input using the keypad 40 with information stored in the memory 52. Depending on the results of this comparison, the microcontroller 50 turns on the transistor 54, which controls operation of the relay 48. When transistor 54 is turned on to actuate the relay 48, a pair of normally open relay contacts are closed, thereby connecting the ignition switch (first) wire 18 with switch (second) wire 20, and enabling the ignition system. When the ignition system has been thusly enabled, microcontroller 50 illuminates the green LED 44, otherwise microcontroller 50 maintains the red LED 42 illuminated.

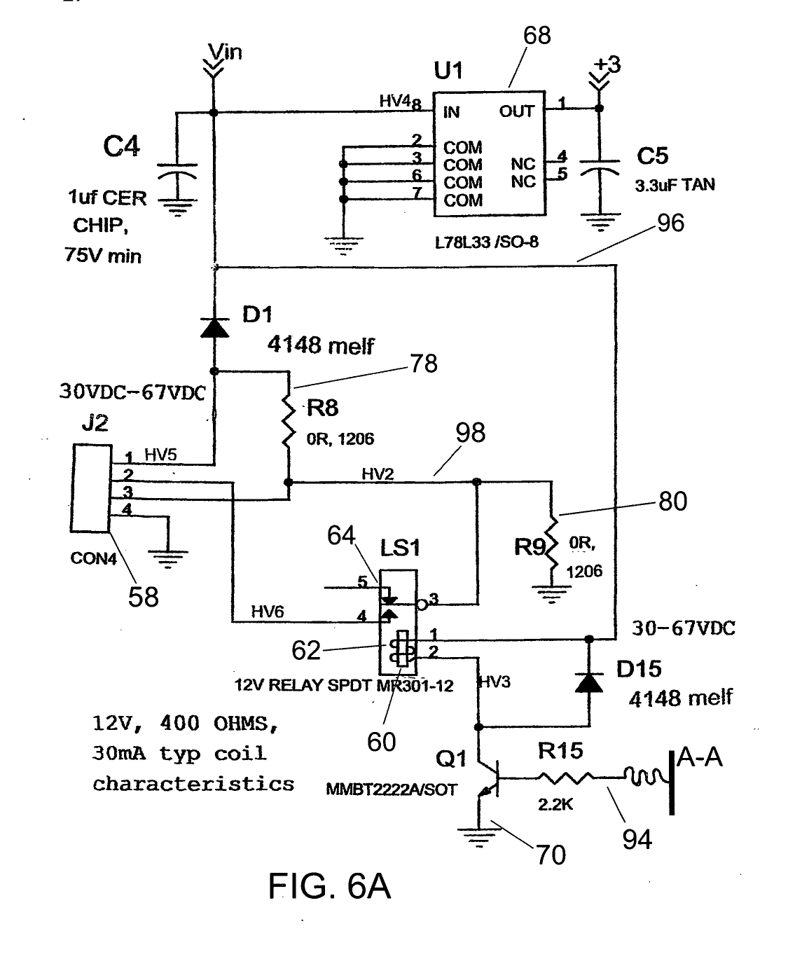

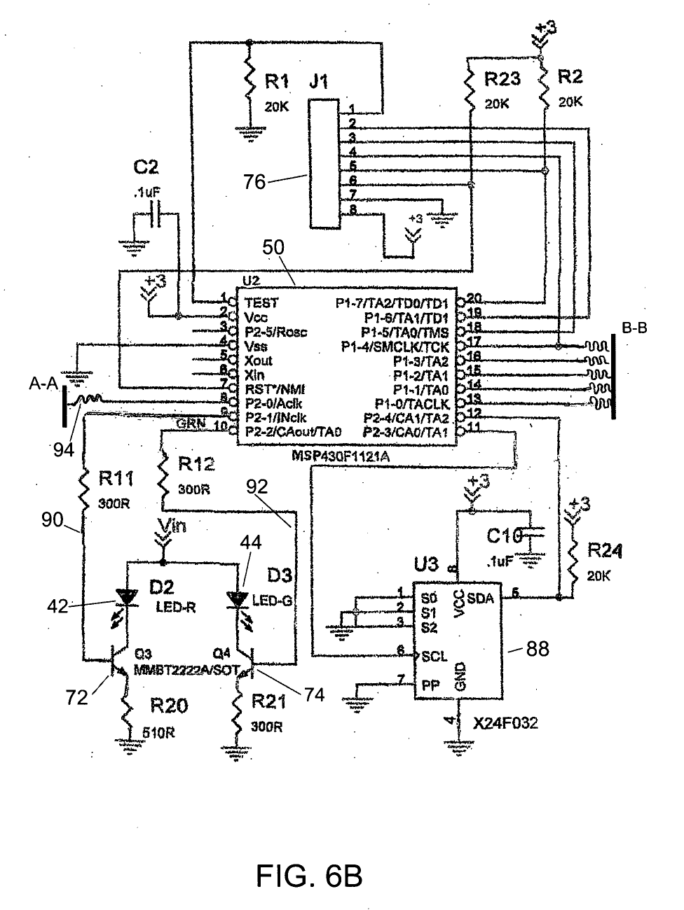

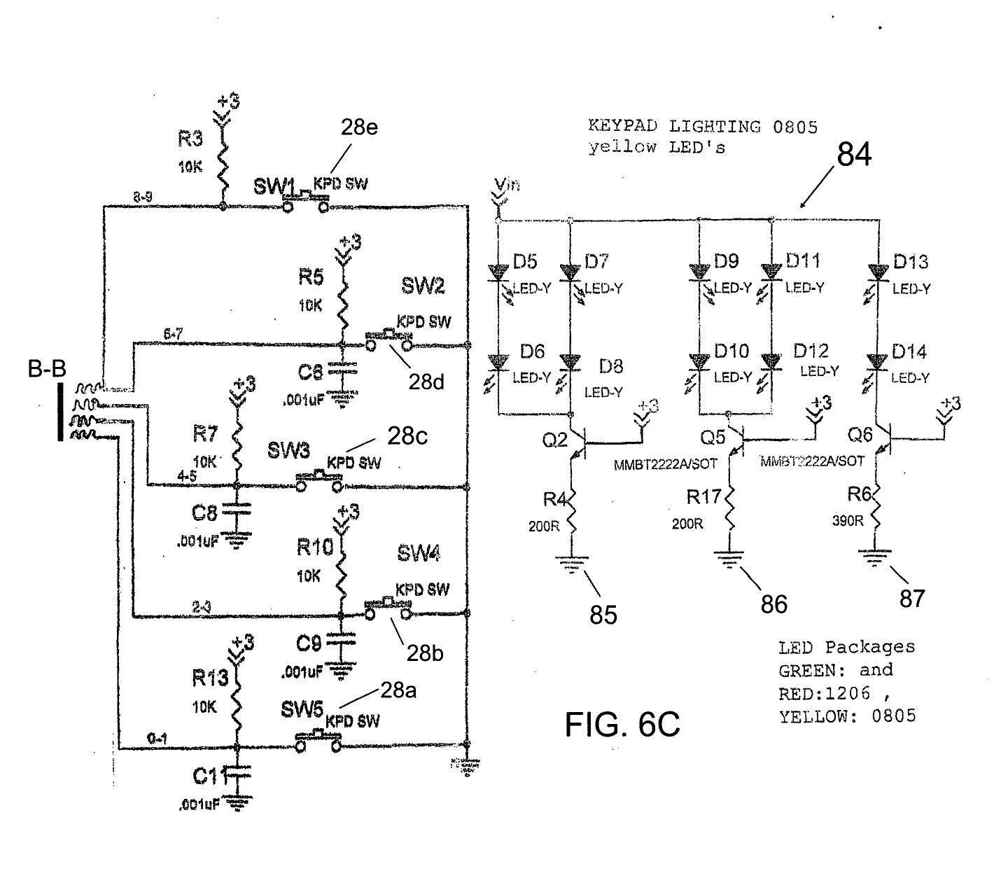

Attention is now directed to FIG. 6, which shows a detailed schematic diagram of the electrical circuit contained on the printed circuit board 30, and related connections. The keypad 26 comprising keypad switches 28a-28e, are connected between ground and five corresponding pin inputs of microcontroller 50. Microcontroller 50 may comprise, for example, a device available from Texas Instruments Corporation and identified by manufacturer's product number MSP430F1121A, sometimes referred to as a mixed signal microcontroller. This particular microcontroller is a low power microcontroller having a 16-bit CPU, registers, constant generators, a digitally controlled oscillator timer, analog computer, and 14 I/O pins. Microcontroller 50 includes both internal RAM and flash ROM, and is connected to a serial flash memory 88 which may comprise, for example, a XICOR serial flash memory carrying the manufacturers model number X24F064/032/016.

Connector 76 includes five leads connected to corresponding pins on the microcontroller 50. Connector 76 is used by a system administrator or technician to carry out programming, testing and troubleshooting functions. A second connector 58 connects the circuitry on the printed circuit board 32 with the vehicle, and includes four pin connections. The first pin connection is coupled to a three terminal, high voltage regulator 68 which may comprise, for example, a model number PL783 manufactured by Texas Instruments. The second and third pins of connector 58 are connected in a series circuit through a pair of switchable contacts 64 forming part of a relay 60. The fourth pin of the connector 58 is grounded.

Microcontroller 50 controls a switching transistor 70, which selectively energizes relay coil 62 that controls normally open relay contacts 64. In most cases where the security system 10 is installed in a switch powered system, the power wire is connected to the ignition switched side.

A series of LEDs 84 controlled by switching transistors 85, 86, 87 provide backlight illumination of the keys 28a-28e.

In operation, actuation of the keys 28a-28e by a vehicle operator deliver signals to the microcontroller 50, collectively forming a binary coded ID number. Microcontroller 50 compares this input code to stored, valid ID codes assigned to one or more authorized users. In the event that the input ID code matches the stored valid code for an authorized operator, a signal is output on line 94 which turns on transistor 70 causing power to be delivered via line 96 through the relay coil 62, thereby energizing the latter. With relay coil 62 energized, relay switch 64 is switched from its normally open position to a closed position, thereby completing the circuit between pins 2 and 3 of connector 58, resulting in the battery being connected to the ignition. Simultaneously, microcontroller 50 delivers a signal on line 92, which turns on transistor 74 causing power to be switched to the green LED 44, illuminating the latter.

When the operator turns off the ignition by opening ignition switch 12 microcontroller 50 is reset and relay 60 is de-energized, thus securing the vehicle until another authorized ID code is input using the security system 10.

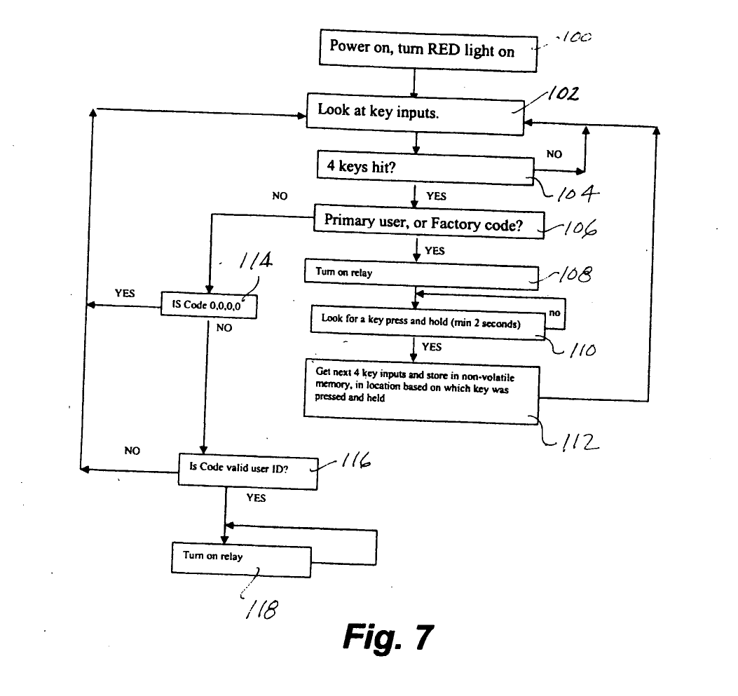

Reference is now made to FIG. 7 which shows the functional steps of the operation of the security system 10. When the operator closes the ignition switch 12, power is turned on at step 100 and the red LED 42 is illuminated, indicating to the operator that the ignition is disabled. The microcontroller 50 constantly reads the keypad inputs at 102 and first determines at 104 whether four keys (28a-28e) have been actuated. If less than four keys have been actuated, the microcontroller 50 continues to read the input until four keys have been actuated. When four keys have been actuated, a determination is made at step 106 of whether the code is that of an authorized primary user or whether the code is a factory code initially set at the time of manufacture. If either the primary ID user code or the initial factory code has been input, the process moves to step 108 where the relay 60 is energized. Then, microcontroller 50 waits to see whether a key 28 has been depressed and held for a minimal period of time, for example, two seconds. In this programming mode, after a key has been held for the minimum requisite time, the process moves to step 112 where the microcontroller 50 receives four keypad inputs forming the authorized user's code. This code is stored in the microcontroller's memory, based on which particular key has been pressed and held. Following this programming sequence, when the user inputs a stored code, the process moves through steps 100-106 and a determination is then made at 114 of whether the code that has been input is 0,0,0,0. If the answer is YES, the microcontroller 50 continues looking at key inputs at 102. However, if the ID code input is other than 0,0,0,0, then a determination is made at step 116 of whether the input code is a valid code for the particular user. If the answer is NO, the microcontroller 50 continues looking at keypad inputs at 102. However, if the answer is YES, then the process moves to step 118 where microcontroller 50 turns on relay 62, thereby enabling the ignition.

The microcontroller 50 can be programmed to implement any of a variety of schemes for recognizing the input codes for each user, and to initially program the system. One typical scheme is described below, by way of example. Initially, a factory code such as 1,2,3,4, is programmed into the microcontroller 50 which, when initially input by an operator, enables the ignition system of the golf cart. In order to initially program a “primary” operator code, the user first turns on the ignition switch 12, whereupon the red LED 42 is illuminated. At this time, the primary user inputs the factory ID code, e.g. 1,2,3,4,. In response, the green LED 44 flashes and then remains on. The primary user then presses and holds the 0/1 key. This will cause the green LED 44 to blink after the key is held for at least two seconds. When the green LED 44 begins blinking, the user then releases the 0/1 key. When the green LED 44 stops flashing, the primary user enters his or her four-digit primary user ID. The red LED 42 will blink each time a key is pressed. After four keys have been pressed corresponding to the user's desired ID, the green LED 44 flashes, indicating the primary user ID has been programmed.

In a similar manner, the primary user (but not other users) may program unique IDs for additional users. In order to add additional users or change the ID of an additional user, the following steps are performed by the primary user. First, the ignition switch 12 is turned on and the primary user waits until the red LED 42 illuminates. The primary user then enters his or her primary user ID, whereupon the green LED 44 flashes and remains illuminated. The primary user then presses and holds the 2/3 key until the green LED 44 flashes, then the user releases this key. When the green LED 44 stops flashing, the primary user enters the four-digit ID for the additional user or enters 0,0,0,0, to delete the user. The red LED 42 blinks each time a key is pressed and a green LED 44 flashes after the fourth key is pressed. The secret user ID for the additional user has now been programmed into the microcontroller 50.

In this example, the 2/3 key is used for adding or deleting the first additional user. This sequence is followed to program ID codes for a second, third and fourth user, except that for the second additional user, the 4/5 key is used, for the third additional user, the 6/7 key is used, and for the fourth additional user, the 8/9 key is used. The additional users can operate the golf cart by turning on the ignition switch 12 and entering their four-digit user ID. However, these additional users cannot change or reprogram any of the user ID numbers, since that function is reserved for the primary user ID. When the security system 10 is operated using a user ID, the keypad is disabled and pressing any of the keys will have no effect.

The primary user ID number can also be changed using the following sequence. First the ignition switch 12 is turned on and the programmer waits for the red LED 42 to illuminate. Then, the programmer enters the primary user ID, whereupon the green light 44 initially flashes and then stops. The programmer presses and holds the 0/1 key until the green LED 44 flashes and then releases the 0/1 key. When the green LED 44 stops flashing, the programmer enters a new secret four-digit primary user ID. The green LED 44 blinks each time a key is pressed. After four keys have been pressed, the green LED 44 flashes signifying that the new primary user id has been successfully programmed into the microcontroller 50. At this point, the old or previously used primary user ID will no longer be accepted by the microcontroller 50.

It is to be understood that the specific systems, methods and techniques which have been described above are merely illustrative of one application of the principles of the invention. Numerous modifications maybe made to the system as described without departing from the true spirit and scope of the invention.

What is claimed is:

1. An electronic key system for a gas powered vehicle having an electric ignition, comprising:
a keypad for allowing an authorized operator of the vehicle to input an identification code (ID code) that identifies the operator;
an electrically controllable switch for selectively enabling operation of the ignition; and,
a controller responsive to the ID code input by the keypad for controlling the switch to enable operation of the ignition.

2. The electronic key system of claim 1, wherein the electrically controllable switch includes a relay having a coil controlled by the controller and a set of switch contacts controlled by the coil and connected in a circuit with the ignition or a solid state relay can be used in place of the coil and contact type relay.

3. The electronic key system of claim 1, wherein the controller includes:
a microcontroller having a central processing unit, and
a memory for storing a set of ID codes identifying authorized operators of the vehicle,
wherein the controller is operative for comparing the ID code input by the keypad with each of the ID codes in the set thereof stored in the memory.

4. The electronic key system of claim 1, wherein the electrically controllable switch includes a switching transistor operated by the controller for selectively connecting the coil with a power supply.

5. The electronic key system of claim 1, including first and second visual indicators operated by the controller for indicating the operational status of the ignition.

6. The electronic key system of claim 1, wherein the controller includes a set of programmed instructions for detecting the ID code input by the keypad, associating each of a plurality of ID codes with authorized operators, comparing the input ID code with each of the plurality of ID codes of authorized operators and controlling the switch to enable the ignition when the input ID code matches one of the plurality of ID codes of authorized operators.

7. The electronic key system of claim 1, including first and second electrical lead wires respectively having first and second terminals that may be connected in a series circuit between the vehicle's ignition switch and a power supply of the vehicle.

8. The electronic key system of claim 1, including a voltage regulator coupled between a power supply on-board the vehicle used to power the vehicle, and the controller, for supplying regulated voltage to the controller.

9. The electronic key system of claim 1, wherein the keypad includes five actuatable keys each allowing the operator to input either of two numbers.

10. The electronic key system of claim 1, including a housing adapted to be mounted on the vehicle, and wherein the controller, the switch and the keypad are mounted in the housing.

11. A security system for restricting access to the ignition of an electric vehicle to authorized operators, comprising:
a keypad for allowing an authorized operator of the vehicle to input an identification code (ID) code uniquely identifying the operator; and,
a control circuit coupled between an ignition switch on the vehicle and an on-board power supply used to power the vehicle, the control circuit including
(a) a memory for storing a plurality of ID codes respectively associated with authorized operators of the vehicle,
(b) an electrically controllable switch for selectively coupling the ignition switch in a circuit with the power supply,
(c) a controller for comparing the input ID code with each of the plurality of ID codes stored in the memory and for actuating the controllable switch to couple the ignition switch in circuit with the power supply when the input ID code matches one of the ID codes stored in the memory.

12. The security system of claim 11, wherein the keypad includes five actuatable keys, each operative for inputting either of two numbers.

13. The security system of claim 11, wherein the controller includes a set of programmed instructions for retrieving the plurality of ID codes from the memory and for comparing the input ID code with the retrieved ID codes.

14. The security system of claim 11, wherein the controllable switch includes a relay having an electrically energizable coil and a pair of normally open switch contacts controlled by the coil and coupled in series with the ignition switch and the power supply.

15. The security system of claim 11, wherein the switch contacts are normally open to disable use of the ignition, but are closed upon energization of the coil to enable use of the ignition.

16. The security system of claim 14, wherein the control circuit includes a switching transistor controlled by the controller and operable to switch power to the relay coil.

17. The security system of claim 11, including a housing in which the keypad and control circuit are contained.

18. The security system of claim 11, wherein the control circuit includes first and second indicator lights operated by the controller for indicating the operational status of the ignition.

19. The security system of claim 11, wherein the controller includes a set of programmed instructions for detecting the ID code input by the keypad, associating each of the plurality of ID codes with authorized operators, comparing the input ID code with each of the plurality of ID codes of authorized operators and controlling the electrically energizable switch to enable the ignition when the input ID code matches one of the plurality of ID codes of authorized operators.

20. The security system of claim 11, wherein the control circuit includes first and second electrical lead wires respectively having first and second terminals that may be connected in a series circuit between the ignition switch and the on-board power supply.

21. A method of restricting access to the ignition of an electric vehicle to authorized operators, comprising:
(A) assigning an ID code to each of a plurality of authorized vehicle operators;
(B) storing the assigned ID codes in a memory;
(C) receiving an ID code input by an operator seeking access to the ignition;
(D) comparing the input ID code with the plurality of ID codes stored in step (B),
(E) enabling the ignition when the ID code compared in step (D) matches one of the ID codes stored in step (B).

22. The method of claim 21, wherein step (A) includes:
assigning a primary operator ID code to a primary operator which allows the primary operator to access to the ignition and to assign ID codes to the non-primary operators, and,
assigning a non-primary ID code to each of a plurality of non-primary operators which allows the non-primary operators access to the ignition but deny the non-primary operators from changing any of the ID codes.

23. The method of claim 21, further comprising storing an initial authorization ID code that can be used by an operator to initially access the ignition before the ID codes are assigned to the operators.

24. The method of claim 21, further comprising retrofitting the vehicle with an ignition control access system for performing steps (A)-(E).

25. The method of claim 24, wherein the retrofitting step includes interposing the access control system between a vehicle ignition switch and an on-board power supply used to power the vehicle.

26. The method of claim 21, wherein:
step (D) is performed using a programmed controller, and
step (E) is performed by controlling a relay to couple an ignition switch with an on-board power supply used to power the vehicle.

27. The method of claim 21, further comprising activating a first indicator light informing the operator that the ignition is disabled, and activating a second indicator light informing the operator that the ignition has been enabled.

28. The method of claim 21, including the step of inputting the ID codes using a keypad on the vehicle.

29. The method of claim 28, wherein a four digit ID code is inputted using no more than 5 keys on the keypad.

30. The method of claim 21, further comprising powering the ignition access control system using power from an on-board power supply used to power the vehicle, and regulating the power used to power the ignition access control system.
